(19) United States
(12) Patent Application Publication
(10) Pub. No.: US 2011/0273953 A1
(43) Pub. Date: Nov. 10, 2011

(54) TANK FOR KNEADING MACHINE

(76) Inventor: Davide DROCCO, Roddi d'Alba (Cuneo) (IT)

(21) Appl. No.: 12/904,413

(22) Filed: Oct. 14, 2010

(30) Foreign Application Priority Data
May 4, 2010 (EP) 10425149.1

(51) Int. Cl. B01F 9/00; B23P 17/00

(52) U.S. Cl. 366/93; 366/69; 29/428

(57) ABSTRACT

A tank comprising a vessel wall and a bottom fixed to said vessel wall. The bottom comprises a portion obtained by chip-removing machining. The tank can be used for a machine for kneading foodstuff substances in which the tank can be driven in rotation by driving means of driving said machine. The aforesaid portion is prearranged for direct engagement with the aforesaid driving means of the kneading machine.

### BACKGROUND OF THE INVENTION

The subject of the present invention is a tank for a kneading machine.

In particular, the present invention teaches producing a tank particularly suited to being applied on rotating-tank kneading machines.

In general, in the field of kneading machines, the tank in which the dough mix is obtained comprises a bottom and a wall of the vessel welded together. According to the known art, both the bottom of the tank and the vessel wall are obtained via cold deformation of plane sheet metal.

The above conventional method intrinsically presents various limits in terms of precision and reproducibility of the desired geometry. The tanks obtained in the conventional way can present, in fact, in addition to considerable deviations from the reference geometry, also significant structural differences within a single lot of tanks of the same type.

All this has adverse repercussions on the quality of the dough. In fact, obviously, given the same type of kneading machine, the structural differences between the tanks result, during working of the dough, in differences in terms of temperature that the dough reaches during operation, of homogeneity of the dough produced, and in general, of energy absorbed by the dough while it is being worked.

In view of the above, it is hence clear that the quality of the dough can vary significantly from machine to machine and that any intervention of control of the quality must necessarily be aimed at the individual machine, thus causing a considerable increase in the production costs thereof.

Furthermore, in the case of rotating-tank kneading machines, the tanks produced in the way indicated above are further coupled to a support prearranged for operative connection to the means of said kneading machines that are designed to drive the tanks in rotation. In a preliminary way, said tanks are, however, subjected to an extremely precise operation of inspection and adjustment of shape, to guarantee respect of the pre-set geometrical tolerances, necessary for proper operation of the machine. Usually, said intervention involves minor deformations of specific regions of the tank that the person responsible for carrying out the inspection must identify and correct one by one. An equally delicate and burdensome intervention is then necessary for fitting together the tank and the aforesaid support, guaranteeing that the axis of the tank is perfectly aligned with the axis of rotation of said support, once again in order to ensure proper operation of the kneading machine.

From the above it emerges then that the installation of a tank of a conventional type on rotating-tank kneading machines is somewhat laborious and costly.

### SUMMARY OF THE INVENTION

The object of the present invention is to overcome the drawbacks referred to above. To achieve said purpose the subject of the present invention is a tank having the characteristics recalled specifically in the ensuing claims.

In various embodiments, the tank comprises a vessel wall and a bottom fixed thereto, in which the bottom comprises a portion prearranged for direct engagement with driving means of the kneading machine.

In various embodiments, the bottom comprises a portion prearranged to constitute a contrast surface for a bottom portion of the vessel wall.

The claims form an integral part of the technical teaching provided herein in relation to the invention.

### BRIEF DESCRIPTION OF THE DRAWINGS

The invention will now be described, purely by way of non-limiting example, with reference to the annexed drawings, in which:

FIG. 1 illustrate a tank according to the known art and successive steps of production of said tank;

FIG. 2 is a cross-sectional view of a tank according to one embodiment;

FIG. 3 is a cross-sectional view of a detail of the tank of FIG. 2;

FIG. 4 is a top plan view of a detail of the bottom of the tank of FIG. 2; and

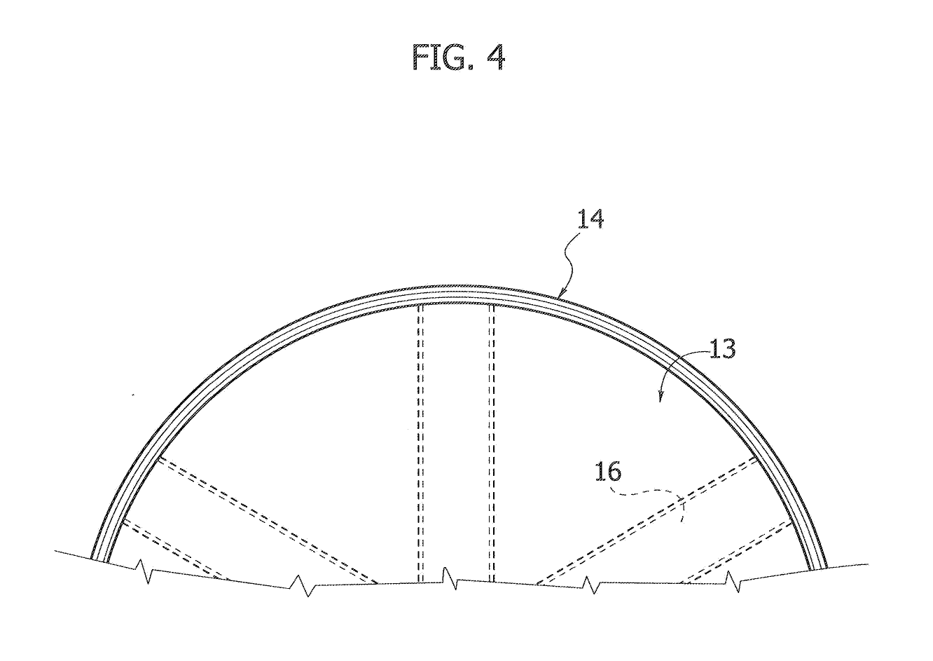

FIG. 5 are cross-sectional views of a detail in the tank of FIG. 2.

### DETAILED DESCRIPTION OF THE INVENTION

Illustrated in the ensuing description are various specific details aimed at providing an in-depth understanding of the embodiments. The embodiments may be obtained without one or more of the specific details, or with other methods, components, materials, etc. In other cases, known structures, materials, or operations are not shown or described in detail so that various aspects of the embodiments will not be obscured.

The reference to “an embodiment” or “one embodiment” in the context of the present description indicates that a particular configuration, structure, or characteristic described in relation to the embodiment is comprised in at least one embodiment. Hence, phrases such as “in an embodiment” or “in one embodiment”, which may be present in different points of this description, do not necessarily refer to one and the same embodiment. Furthermore, particular conformations, structures, or characteristics can be combined adequately in one or more embodiments.

The reference numbers appearing herein are used only for reasons of convenience and hence do not define the sphere of protection or the scope of the embodiments.

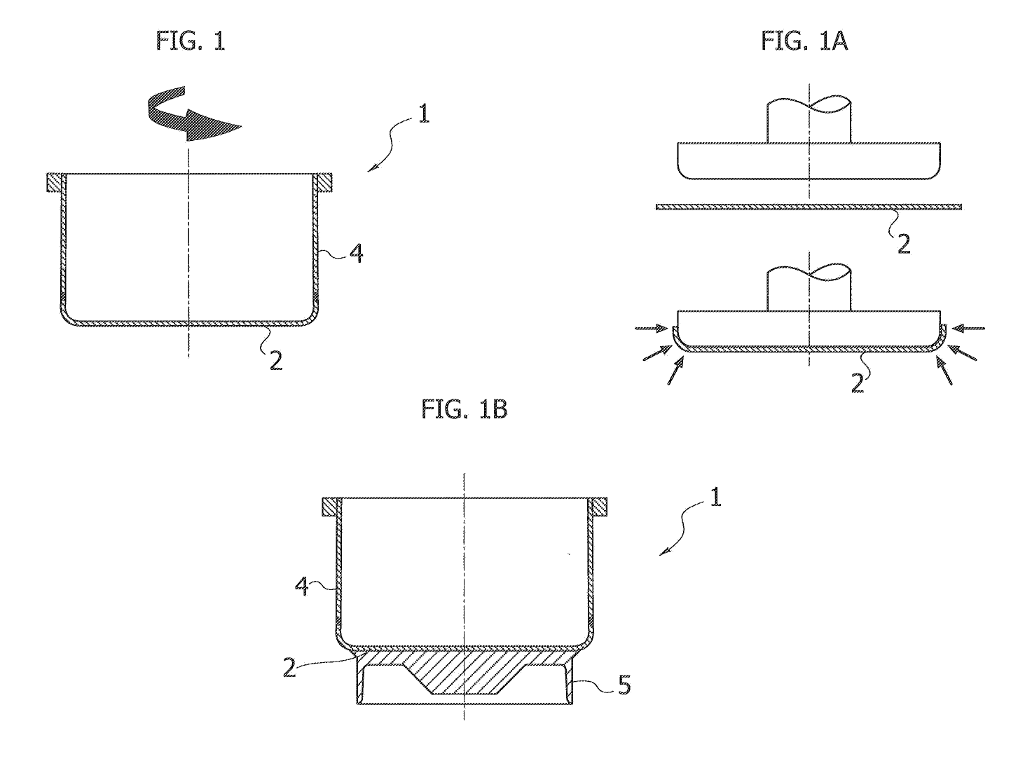

FIG. 1 illustrates a tank 1 according to the known art. Said tank comprises a bottom 2 and a vessel wall 4, welded together. As may be seen in FIG. 1a, the bottom 2 is obtained via successive steps of cold pressing of plane sheet metal. The vessel wall 4 is instead obtained via rolling. As already mentioned above and schematically illustrated in FIG. 1B, in the case where the tank is to be used on a rotating-tank kneading machine, the tank is further coupled to a support 5 prearranged for being operatively connected to driving means of the kneading machine.

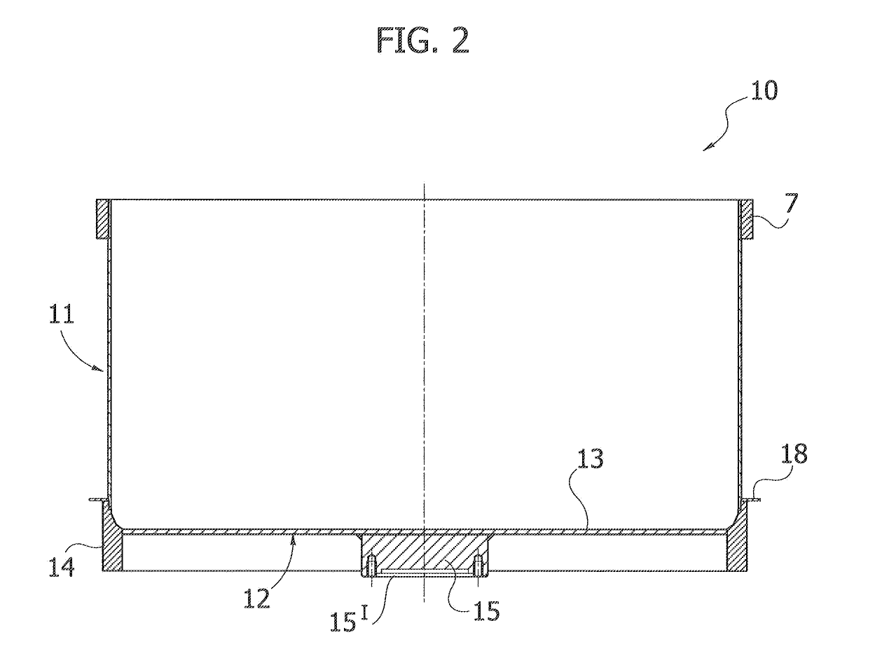

FIG. 2 illustrates a tank according to an embodiment of the present invention. Designated as a whole by the reference number 10 is the tank. It is constituted by a vessel wall 11 and by a bottom 12, fixed together by welding.

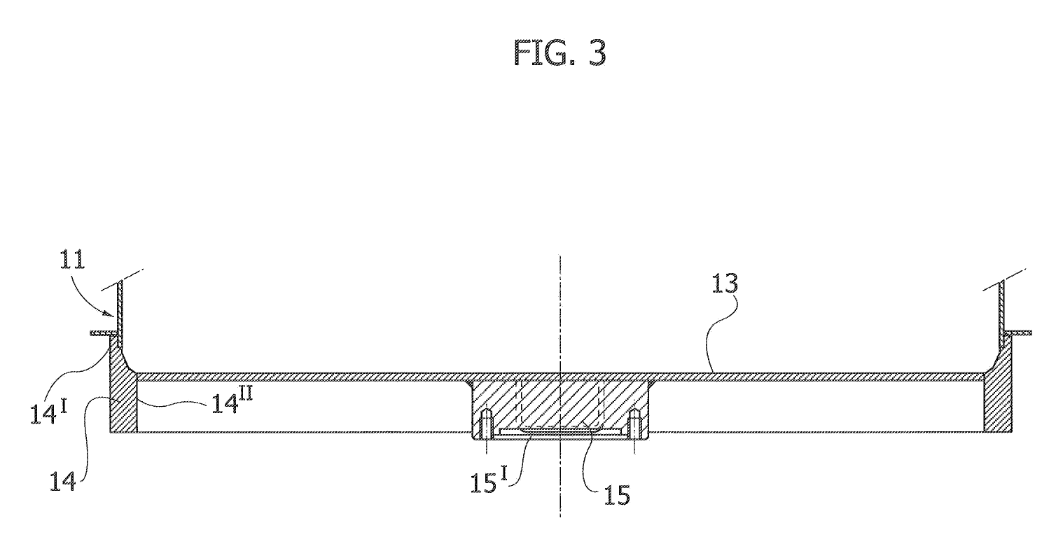

Shown in detail in FIG. 3 is the bottom 12. It comprises a disk 13 defining the inner bottom wall of the tank 10 and a circular band 14, which envelops the disk 13 and to which the disk 13 is fixed by welding.

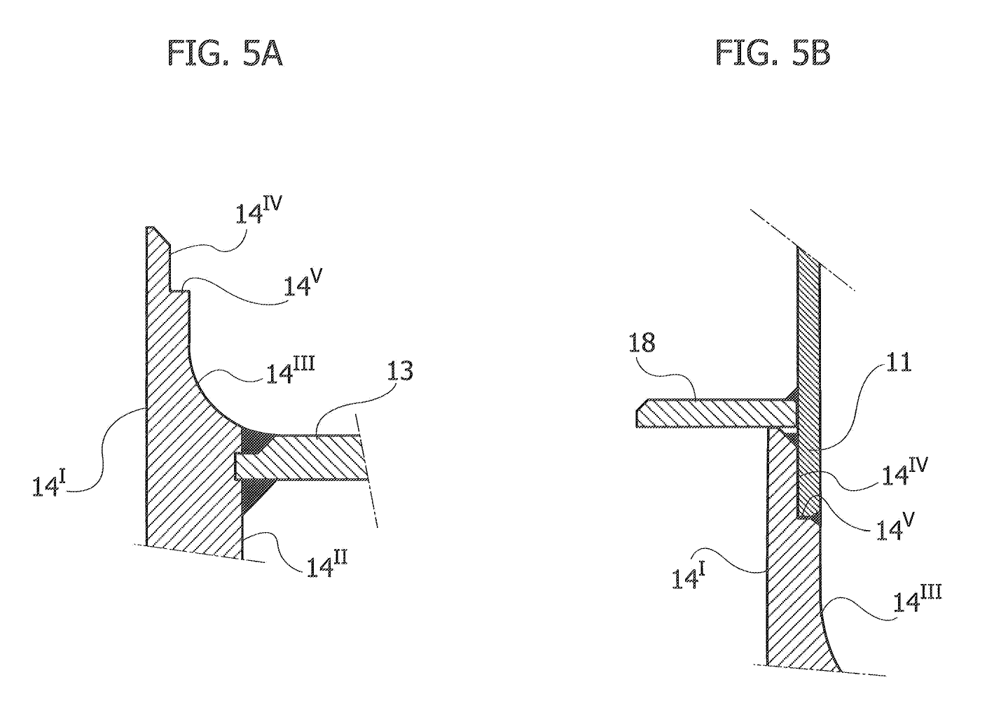

With reference to the detail of FIGS. 5, the band 14 defines an outer cylindrical surface 14^{I} prearranged, as will be described in what follows, for direct engagement with driving means of the kneading machine. On its inner side, the band 14 defines, instead, from beneath upwards as viewed in FIG. 5, an inner cylindrical surface 14^{II}, a radiusing surface 14^{III}, and a further inner cylindrical surface 14^{IV}.

The inner cylindrical surface 14^{II} identifies a portion of larger thickness of the band 14 on which the disk 13 is fixed. In particular, as may be seen in FIG. 5B, the disk 13 is welded on its outer rim to a top end portion of the surface 14^{II}.

The cylindrical surface 14^{IV} identifies, instead, a restricted portion of the band 14 that delimits an internal horizontal edge 14^{V}, on which, as may be seen in FIG. 5B, the bottom edge of the vessel wall 11 rests. The cylindrical surface 14^{Iv} serves instead as contrast wall for the bottom portion of the outer wall of the vessel wall 11, imposing on the latter a perfect circular configuration.

As may be seen in FIG. 5B, the surface 14^{III} constitutes a radiusing surface between the bottom wall of the tank, defined by the upper side of the disk 13, and the inner side wall of the tank, defined by the inner wall of the vessel wall 11.

Fixed by welding on the underside of the disk 13 is a central disk 15 prearranged for engagement, via its attachment portions 15′, with the structure of the kneading machine, for installation of the tank 10 itself on the latter.

Once again radially fixed on the underside of the disk 13 is a series of sectional elements 16 that connect the disk 15 with the cylindrical surface 14^{II} of the band 14. The sectional elements 16 have a function of stiffening the bottom of the tank, above all in regard to torsional loads about the axis of the tank.

The vessel wall 11 has on its outer top edge a stiffening ring 17, anchored in place by welding.

With reference once again to FIG. 5b, a circular ring 18 bears upon the top edge of the band 14, about the vessel wall 11, with the function of constituting a barrier to prevent dribbling of the dough around the outer surface of the tank.

As mentioned previously, the cylindrical surface 14^{I} is prearranged for direct engagement with the means for driving the tank, provided in the kneading machine, which are generally constituted by one or more friction wheels. For proper driving of the tank by said means it is necessary for said surface to have a well-defined geometry. In various embodiments, the cylindrical surface 14^{I} is obtained via a machining operation with removal of stock, for example a machining operation of turning.

In various embodiments, the band 14 is designed to engage the vessel wall so as to impose the desired geometry thereon. As seen above, in the embodiment described previously, this is obtained by envisaging on the band 14 the cylindrical surface 14^{IV}, designed to define a contrast surface for the bottom portion of the vessel wall 11. In various embodiments, the cylindrical surface 14^{IV} is obtained via a machining operation with removal of stock, for example a machining operation of turning.

In various embodiments, the band 14 moreover defines a radiusing surface 14^{III} between the bottom wall of the tank and its inner side wall. It should be noted that the geometry of said surface affects in a determining way the work that the kneading tools perform on the dough. Hence, the fact that said surface is obtained on the band 14 enables an absolutely precise reproduction of the design geometry. In various embodiments, said radiusing surface 14^{III} is obtained via a machining operation with removal of stock, for example a machining operation of turning.

In what follows, the process of production of the tank will be described according to one embodiment.

Said process envisages respective steps for the production of the bottom and of the vessel wall.

With reference to the vessel wall, it is to be noted that it can be produced in any known way to obtain its characteristic tubular conformation. In various embodiments, a plane metal sheet is rolled and then closed by welding. Next, the ring 17 described above is fixed, by welding, on the top portion of said closed metal sheet, to achieve stiffening thereof.

The production of the bottom envisages instead forming, first, the ring or metal band that will then come to constitute the band 14 described above. In various embodiments, said ring is obtained via rolling of a polygonal bar, which is then closed by welding. It should be noted, however, that other methods suited to said purpose can be equally used. Next, welded to the ring or band formed is, in the configuration described previously, the disk 13, and then fixed on the underside of said disk are, once again by welding, the central disk 15 and the sectional elements 16. Finally, the band undergoes a machining operation with removal of stock, for example a machining operation of turning, to produce one or more of the surfaces 14^{I}, 14^{II}, 14^{III}, 14^{IV} and 14^{V} referred to above.

Once the bottom 12 is completed, the vessel wall 11 is then fixed to the bottom itself, and finally the ring 18 is fixed to the band 14.

The tank obtained adopting the process described above is immediately ready to be installed on a kneading machine.

In particular, in the case of applications on rotating-tank kneading machines, said tank can be immediately mounted on the kneading machine, in direct contact with the driving means of said machine designed to drive in rotation the tank itself.

It should be noted that the configuration of the tank described above enables a simpler and effective inspection of the geometries.

In fact, the radiusing surface 14^{III}, the contrast surface 14^{IV}, as also the other portions of the band 14, all co-operate in the function of defining precisely the geometry of the tank, which may hence be reproduced any number of times in as many tanks of the same type.

Furthermore, in various embodiments in which the band 14 comprises a portion designed to come into direct engagement with the driving means of the kneading machine, the geometries of the band 14 guarantee directly, and at the same time, both rotational symmetry of the tank and alignment between the axis of the tank and the axis about which the latter will be set in rotation.

In view of the above, the tank configuration according to the present invention enables guarantee of a greater precision of production and a better reproducibility of the shapes. Said configuration guarantees, in particular, that the tanks of one and the same type have the same geometrical characteristics so that the kneading implements are in the condition to work on the dough in the same way, and consequently a homogeneous quality of dough is obtained for all the machines. Furthermore, the geometrical correspondence between the tanks not only yields advantages as regards working of the dough but also considerable facilitation of the process of cleaning of the tanks themselves, such as for example the fact that the cleaning means can envisage a single configuration for all the tanks.

The turning operation to which the band 14 can be subjected moreover enables even very strict geometrical tolerances to be obtained.

Of course, without prejudice to the principle of the invention, the details of production and the embodiments may vary, even significantly, with respect to what has been illustrated herein purely by way of non-limiting example, without thereby departing from the scope of the invention, as defined by the annexed claims.

1. A tank comprising a vessel wall and a bottom fixed to said vessel wall,
wherein said bottom comprises a portion obtained by chip-removing machining.

2. The tank according to claim 1, in particular for a kneading machine in which the tank can be driven in rotation by driving means of said machine, wherein said portion of said bottom is prearranged for direct engagement with said driving means.

3. The tank according to claim 1, wherein fixed on said portion is said vessel wall.

4. The tank according to claim 1, wherein said portion has a contrast wall for a bottom portion of said vessel wall.

5. The tank according to claim 2, wherein portion defines a substantially cylindrical outer surface coaxial to said vessel wall, prearranged for direct engagement with said means for driving the tank.

6. The tank according to claim 1, wherein said portion defines a substantially cylindrical inner surface designed to constitute a contrast for a bottom portion of said vessel wall.

7. The tank according to claim 1, wherein said portion is formed by a circular band.

8. The tank according to claim 7, wherein bottom comprises a disk around which said band is wound and to which it is fixed.

9. The tank according to claim 1, wherein portion has an outer surface, prearranged for direct engagement with said means for driving the tank, which is obtained by means of a process of turning.

10. The tank according to claim 1, wherein said portion has a substantially cylindrical inner surface designed to constitute a contrast for a bottom portion of said vessel wall, which is obtained by means of a process of turning.

11. The tank according to claim 8, wherein it comprises a substantially central portion fixed on the underside of said disk and prearranged for engagement with the structure of said kneading machine.

12. The tank according to claim 11, wherein it comprises a circular series of sectional elements, fixed on the underside of said disk, which surrounds said central portion, from said central portion said sectional elements extending in a substantially radial direction.

13. The tank according to claim 1, wherein said portion defines a radiusing surface between the bottom wall of the tank and its inner side wall.

14. A method for the production of a tank comprising the steps of:
producing a vessel wall;
producing a bottom; and
connecting said bottom to said vessel wall,
said method being characterized in that a portion of said bottom is subjected to a chip-removing machining operation.

15. The method according to claim 14, in particular for producing a tank for a kneading machine, in which the tank can be driven in rotation by driving means of said machine, said method being characterized in that said portion of said bottom is obtained so as to be prearranged for direct engagement with said means for driving the tank.

16. The method according to any claim 14, wherein said portion is made so as to constitute a contrast wall for a bottom portion of said vessel wall.

17. The method according to claim 14, wherein it envisages producing a circular band and turning thereon an outer wall designed for direct engagement with said driving means.

18. The method according to claim 17, wherein it envisages turning on said band an inner wall designed to constitute a contrast for a bottom portion of said vessel wall.

19. The method according to claim 17, wherein it envisages enveloping, with said circular band, a disk designed to define the bottom wall of said tank, which is fixed on the band itself.
